(19) United States
(12) Patent Application Publication
(10) Pub. No.: US 2026/0074917 A1
(43) Pub. Date: Mar. 12, 2026

(54) FINE-GRAINED CONTROL FOR CLIENT ACCESS TO NETWORK SERVICES

(71) Applicant: Fortanix, Inc., Santa Clara, CA (US)

(72) Inventors: Jethro Gideon Beekman, Eindhoven (NL); Gijsbrecht Natanaël Kwakkel, Lienden (NL)

(21) Appl. No.: 18/883,364

(22) Filed: Sep. 12, 2024

(51) Int. Cl. H04L 9/32; H04L 9/08

(52) U.S. Cl. CPC H04L 9/3268; H04L 9/0825; H04L 9/3247

(57) ABSTRACT

A request of a service client of a user device for authentication data to access a service provided by a host server is received by an authentication agent of the user device. An access certificate from an access control server is requested by the authentication agent. The request comprises one or more compliance indicators of the user device associated with one or more compliance requirements for accessing the service. The access certificate is received from the access control server by the authentication agent. The access certificate comprises an indication that the user device complies with the one or more compliance requirements, and a digital signature of the access control server. The access certificate is provided to the service client. The access certificate is to be sent to the host server for validation using a public key of the access control server.

### TECHNICAL FIELD

Aspects and embodiments of the present disclosure relate to network services, and in particular to fine-grained control for client access to network services.

### BACKGROUND

A network service is a network-connected application that provides various capabilities such as communication, data storage, computation, etc. Network services may operate across various networks, such as local area networks (LANs), wide area networks (WANs), the Internet, etc. A network service may be a hosted service, which may be provided by a server to one or more clients. A network service may also be peer-to-peer between servers and/or clients. Network services may be centralized (e.g., at a single server or at servers within a datacenter) or decentralized (e.g., provided by various peers, clients, or servers working together across different geographic regions).

### BRIEF DESCRIPTION OF DRAWINGS

Various embodiments in accordance with the present disclosure will be described with reference to the drawings, in which:

FIG. 1 is a block diagram of an example system architecture for providing fine-grained control for client access to network services, in accordance with an embodiment;

FIG. 2A depicts an example protocol for client-side communication between service client applications and authentication agents, in accordance with an embodiment;

FIG. 2B depicts an example protocol for server-side communication between service provider applications and access agents, in accordance with an embodiment;

FIG. 3 is a block diagram of an example client access certificate, in accordance with an embodiment;

FIG. 4 is a communication diagram of an example interaction between devices for providing fine-grained control for client access to network services, in accordance with an embodiment;

FIG. 5 is a flow diagram of an example method for providing fine-grained control for client access to network services, in accordance with an embodiment;

FIG. 6 illustrates an example network server having an access control service for providing fine-grained control for client access to network services, according to an embodiment; and

FIG. 7 illustrates an example computer system, in accordance with an embodiment.

### DETAILED DESCRIPTION

Aspects of the present disclosure relate to fine-grained control for client access to network services. A network service is a network-connected application that provides various capabilities such as communication, data storage, computation, and combinations of the above and other capabilities. Network services may operate across various networks, such as local area networks (LANs), wide area networks (WANs), the Internet, or similar networks. A network service may be or include a hosted service, which may be provided by a server to one or more clients. A network service may also be or include a peer-to-peer service between servers and/or clients. Aspects of the present disclosure described with respect to service providers and clients may also apply to hosted or peer-to-peer services. Network services may be centralized (e.g., at a single server or at servers within a datacenter) or decentralized (e.g., provided by various peers, clients, or servers working together across different geographic regions). Examples of network services include websites and web applications, Secure Shell (SSH) and Remote Desktop Protocol (RDP) for remote login and command execution, and Virtual Private Network (VPN) endpoints for connecting to private networks over public networks.

In some network services, service client applications may authenticate with service provider applications (e.g., a host server application) before they are permitted to connect to a service. For example, service client applications may provide a password, a hash, a cryptographic key, or other token to the service provider application to prove the identity or access privilege of the service client application. If the service client application does not provide the required authentication to the service provider application, the service provider application may restrict or disallow access to the service. Access restriction may provide various security, economic, and other benefits for the service provider application. For example, access restriction enables the service provider application to turn down connections from unknown malicious actors or non-customers and to allow access to credentialed employees or customers. For some network services, client-side or server-side authentication may be handled by authentication agents that are separate from the service client or provider applications. On the client side, authentication agents may provide for multiple types of authentication (e.g., password, USB security key, certificate, etc.), and service client applications may interact with different services. Authentication agents and service client applications may communicate with each other using shared protocols to provide flexible authentication for various services. An example protocol is the ssh-agent protocol, which connects the ssh-agent application with various SSH-based service client applications such as ssh and scp. Similarly, on the provider side, various types of authentication or access agents (e.g., Pluggable Authentication Modules (PAM) or Name Service Switch (NSS)) may interact with service provider applications over shared protocols to authenticate service client applications connecting to the service. Once a client has been authenticated and granted access to a service, access may continue under various timing conditions. For example, a connection may automatically end after a set period of time regardless of activity, or a connection may end after a set time of inactivity. Timing conditions may be managed by authentication agents or service applications on the client or server side. A provider or client may end a connection based on other conditions (e.g., a user may close a session after their purpose has been accomplished).

Some network services such as those described above face several challenges related to controlling access from users. In some scenarios, a service provider may want to control access for service client applications based on the underlying hardware and software of the client device that the service client application is using. For example, an organization may want to ensure that employees'computers meet various compliance requirements before allowing access to the organization's VPN. In another example, a service may require clients to have sufficient resources available (e.g., RAM) before connecting. Some services may be unable to verify these requirements before allowing access (e.g., the host may have to connect to the client before the host can query the client about its capabilities and configurations). Clients may be able to advertise some of their capabilities before connecting to the service, but the client or their advertisement may not be trustworthy before a connection is established.

Another challenge faced by some systems relates to continued client compliance with access requirements after a connection with the service has been established. Client devices may change their capabilities or configurations (e.g., intentionally or unintentionally) during a service session and may fall out of compliance with the initial access requirements. Service provider applications may continue the connection unaware of the changes, which may have security implications or cause other problems. Service provider applications may need to change an access level of the service (e.g., increase access for more service capabilities or decrease access) or end the service session when a client's compliance changes.

As a result of these and other challenges, services and service providers may experience increased vulnerability to non-compliant clients before and during service sessions, which may lead to security breaches (e.g., data theft or loss), economic losses, and other losses and liabilities. Service providers may attempt to mitigate by, e.g., developing custom service provider applications and service client applications that provide custom authentication and compliance protocols. These custom provider and client applications may implement the service protocols of the original provider and client applications that they replace, but they may not implement the shared protocols previously used to communicate with server-side and client-side authentication agents (e.g., because custom authentication is being provided instead). Developing these custom provider and client applications may be costly for service providers and users. Service providers may waste developer time and resources by duplicating existing provider and client application functionality to provide custom authentication and compliance protocols in the custom provider and client applications. The resulting custom provider and client applications may have limited portability (e.g., may only work on one operating system) and may have imperfections (e.g., bugs) or be difficult to use for service users. It may remain difficult for services to establish trust with client devices despite these custom provider and client applications. Service users may be further burdened by these mitigations and the lack of compatibility with existing authentication infrastructure and workflows. For example, a user may be accustomed to using both ssh and scp client applications on Linux as part of their normal workflow and may have ssh-agent configured to provide authentication for both. If the user is provided with a custom Windows® ssh client application implementing custom authentication and compliance protocols required to access ssh on a particular server, the user may now be unable to use scp or Linux® and may have to change their workflow. These challenges and mitigations may lead to increased costs and burdens associated with providing and using network services.

Aspects of the present disclosure address the above and other challenges of the existing technology by providing fine-grained control for client access to network services. In an embodiment, an access control server and authentication/access agents are provided. The access control server may be a trusted intermediary for network services that can verify client compliance with access requirements before and during service sessions. The access control server may be configured with compliance profiles corresponding to the access requirements of different services and different capabilities or access levels within services. The access control server may communicate with an authentication agent on a client device to determine whether the client device (and applications thereon) complies with the access profile for a particular service. For example, the access control server may receive compliance indicators from the authentication agent. The access control server may further engage with the authentication agent in various protocols to establish the integrity of compliance information received from the client device. The access control server may generate and sign a certificate indicating the client device's compliance with the compliance profile and may provide it to the authentication agent. One of several service client applications compatible with the authentication agent may request authentication data from the authentication agent, which may in turn provide the certificate to the requesting client application. The client application may subsequently provide the certificate to the service provider application to access the service. The service provider application may provide the received certificate to a server-side access agent, which may verify the access control server's digital signature (e.g., using a trusted certificate authority) and may communicate with the operating system and other applications of the server device to configure permissions, groups, etc. for the connecting client. The client may be granted access to the service or capabilities within the service corresponding to the compliance indication in the access certificate.

In an embodiment, access certificates provided by an access control server may be limited-duration access certificates. For example, an access certificate may expire within a few minutes, hours, days, etc., depending on the security context or other context of a particular service. The client authentication agent may thus be required to communicate with the access control server on a regular basis to ensure continued compliance with the compliance profile and to obtain new limited-duration access certificates. If the service provider application receives an access certificate indicating a change in a compliance profile, the service provider application may determine to expand access to the service, reduce access to the service, end the service session, etc.

Accordingly, systems using the techniques described herein can provide fine-grained control for client access to network services that enables client characteristics and configurations to be verified before establishing a connection to a service, and to be continually verified during a service session at appropriate intervals. Authentication and access agents may improve security and reduce vulnerabilities for servers and clients while maintaining compatibility with existing workflows and tools. Service providers can have greater trust in client compliance by using a trusted intermediary with trusted protocols for verifying client compliance. Service providers can also provide fine-grained control of access to services and capabilities by providing limited-duration access and updating access when client compliance changes. Clients, in turn, may experience fewer burdens and increased convenience when connecting to various services. Thus, potential costs and liabilities for all parties may be reduced.

### System Architecture

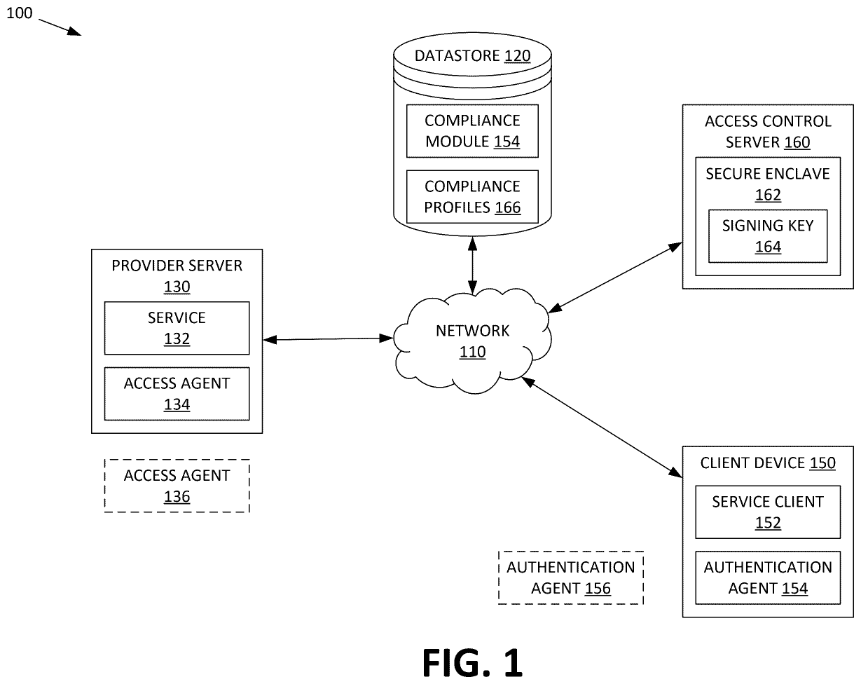

FIG. 1 is a block diagram of an example system architecture 100 for providing fine-grained control for client access to network services, in accordance with at least one embodiment. System architecture 100 (also referred to as “system” herein) includes network 110, datastore 120, provider server 130, client device 150, and access control server 160. In various embodiments, system 100 may include more or fewer components in different configurations than those depicted in FIG. 1. For example, system 100 may include additional client devices or provider servers in an embodiment.

Network 110 may include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. For example, network 110 may include a plurality of the above types of networks connected together via a VPN, the Border Gateway Protocol (BGP), or other protocol. Network 110 or components thereof may be associated with different organizations in various embodiments. For example, components of network 110 may be associated with Internet Service Providers (ISPs), mobile or cellular carriers, cloud platform or software-as-a-service (SaaS) providers, private or public enterprises, private households or communities, etc. In an embodiment, network 110 (or a component thereof) may be a physical or virtual interconnect within a single device, such as a PCIe bus, a messaging system, or an API.

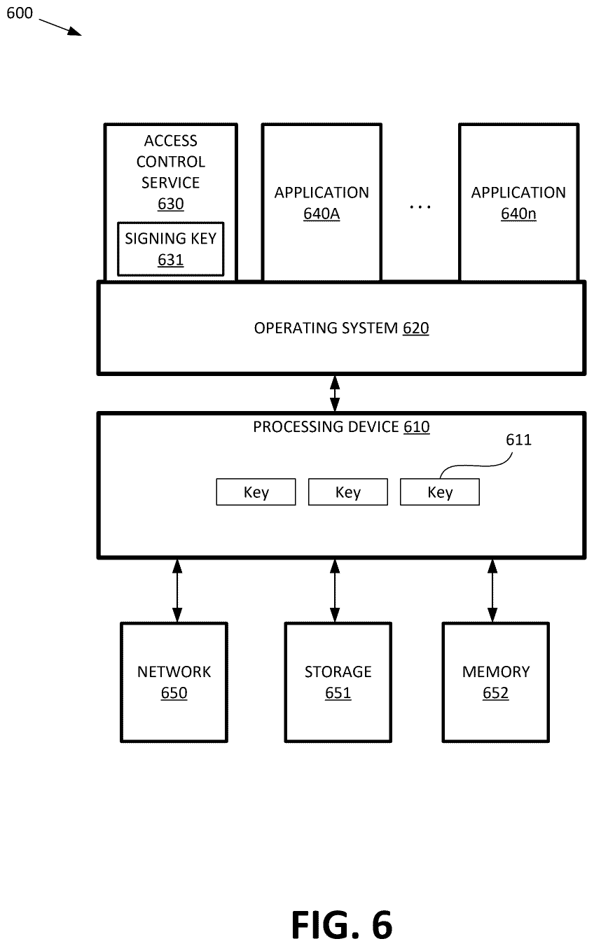

Datastore 120 may include one or more persistent storage devices such as magnetic tapes or drives, solid-state drives, optical drives or similar (e.g., other storage technologies discussed with respect to FIG. 6). Datastore 120 may also include storage devices in a networked topology, such as a Storage Area Network (SAN), Network-Attached Storage (NAS), cloud-provisioned storage, or similar. Datastore 120 may be shared by other components (e.g., provider server 130 and access control server 160), or system 100 may include multiple datastores 120 each associated with one or more components. For example, servers 130 and 160 may each have a datastore connected over a network or connected locally via, e.g., a PCIe or SATA bus. In an embodiment, datastore 120 may be some other type of persistent storage such as an object-oriented database, a relational database, and so forth, that may be hosted by servers 130 and 160 or one or more different machines coupled to network 110.

Each of provider server 130, client device 150, and access control server 160 may be a personal computer (PC), a laptop computer, a notebook computer, a mobile phone, a smartphone, a tablet computer, a digital assistant, a rackmount server, a router computer, or similar computing device. An example computing device is further described with respect to FIG. 6. Each of provider server 130, client device 150, and access control server 160 may also be a virtualized resource such as a virtual machine (VM) or a containerized application. Each of provider server 130, client device 150, and access control server 160 may also correspond to a collection of physical or virtual computing resources, such as a datacenter or a collection of servers or VMs distributed across multiple data centers. For example, servers 130 and 160 may correspond to cloud computing resources provisioned from a cloud computing provider. Each of provider server 130, client device 150, and access control server 160 may run an operating system or one or more software applications.

Provider server 130 may provide one or more services over network 110, such as service 132. Examples of services that may be provided include websites, web applications, remote login (e.g., SSH), remote desktop (e.g., RDP), remote hardware and software management (e.g., baseboard management controller (BMC), router or switch management interface, cloud platform management console), private networking (e.g., VPN), database access and management, telecom and messaging, etc. Provider server 130 may correspond to a host in a host-client service or a peer in a peer-to-peer service. Provider server 130 may further correspond to a plurality of computing devices working together to provide a centralized or decentralized service. Provider server 130 may perform various activities in connection with providing service 132. For example, provider server 130 may perform computations, write to and read from volatile or non-volatile memory and storage (e.g., RAM, datastore 120), communicate with other computing devices or applications (e.g., via network 110 or internal buses), receive user input, provide output to a user, etc.

Client device 150 may correspond to one or more client users associated with provider server 130 and service 132. For example, client device 150 may be used by a client user to interact with service 132. Client device 150 may correspond to a client in a host-client service or a peer in a peer-to-peer service. Client device 150 may include service client 152 for communicating with service 132. Service client 152 may be hardware (e.g., circuitry, dedicated logic), software (e.g., an application, library, or framework), or a combination thereof in various embodiments. Example service clients include OpenSSH and PuTTY clients for SSH services, and web browsers for various web applications and websites.

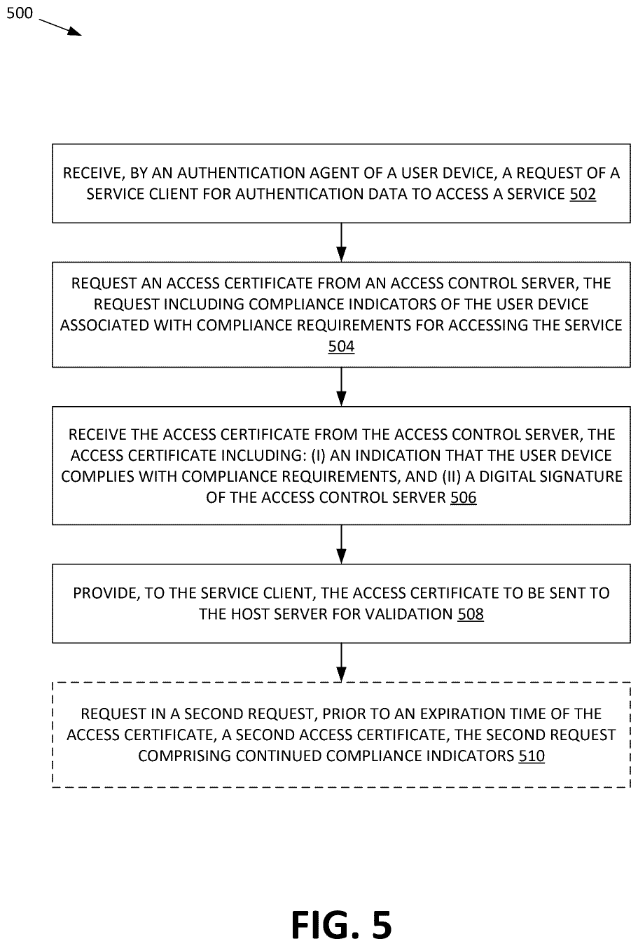

Access control server 160 may provide access control and client compliance verification in relation to service 132. For example, access control server 160 may provide one or more compliance profiles (e.g., compliance profiles 166) to client device 150 and receive compliance information from client device 150 (via authentication agent 154). Access control server 160 may also receive compliance profiles or requirements from provider server 130 (or administrator thereof) and may issue access certificates for service 132 if client device 150 is compliant with the requirements. Access control server 160 may include secure enclave 162 to store signing key 164, compliance profiles 166 or other data. Secure enclave may also perform secure operations such as signing access certificates with signing key 164, communicating with client devices for integrity protocols, etc. Secure enclaves and multi-purpose servers having secure enclaves are further discussed with respect to FIG. 5.

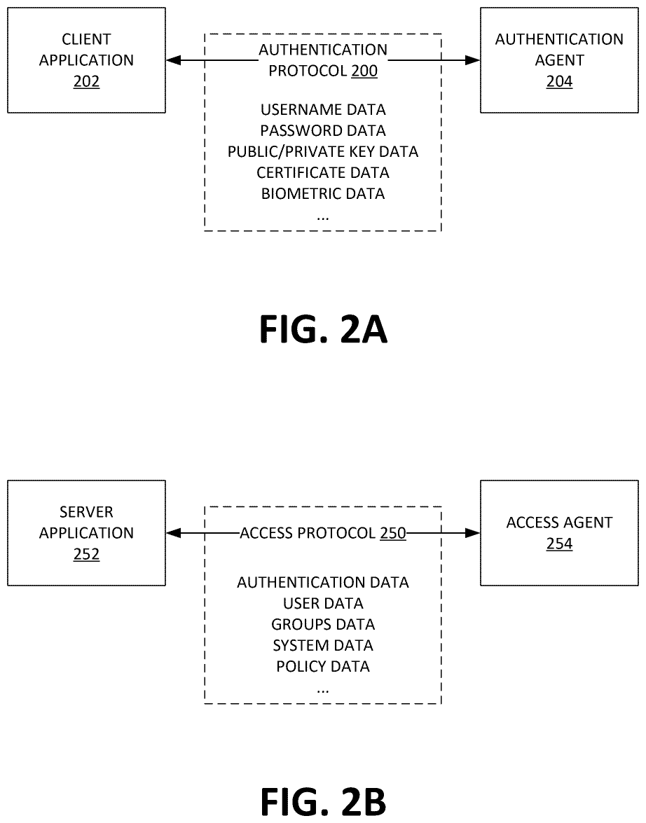

Provider server 130 may further include access agent 134 for user authentication, login, group management, and other tasks interfacing service 132 with the operating system or other components of provider server 130. Service 132 and access agent 134 may communicate using an access protocol such as an application programming interface (API) or inter-process communication (IPC) protocol. Various services and access agents may thus be compatible with each other due to the shared protocol. Examples of services that may be compatible with various access protocols are given above. Examples of access agents that may be compatible with various access protocols include Pluggable Authentication Modules (PAM) and Name Service Switch (NSS). As depicted in FIG. 1, access agent 134 may be an access agent in communication with access control server 160, while access agent 136 may be an access agent not in communication with access control server 160. For example, access agent 136 may be a PAM module supporting password authentication. Access protocols and interchangeable services and access agents are further described with reference to FIG. 2.

Client device 150 may further include authentication agent 154 for communicating with access control server 160 and ensuring that client device 150 is compliant with one or more compliance profiles required for accessing service 132. Service client 152 and authentication agent 154 may communicate using an authentication protocol such as an API or IPC protocol, and various service clients and authentication agents may thus be compatible with each other and interchangeable. Examples of service clients that may be compatible with various authentication protocols include ssh, scp, WireGuard, VPN clients, etc. Examples of authentication agents that may be compatible with various access protocols include password managers, ssh-agent, etc. As depicted in FIG. 1, authentication agent 154 may be an authentication in communication with access control server 160, while authentication agent 156 may be an authentication agent not in communication with access control server 160. For example, authentication agent 156 may be a local password manager. Authentication protocols and interchangeable service clients and authentication agents are further described with reference to FIG. 2.

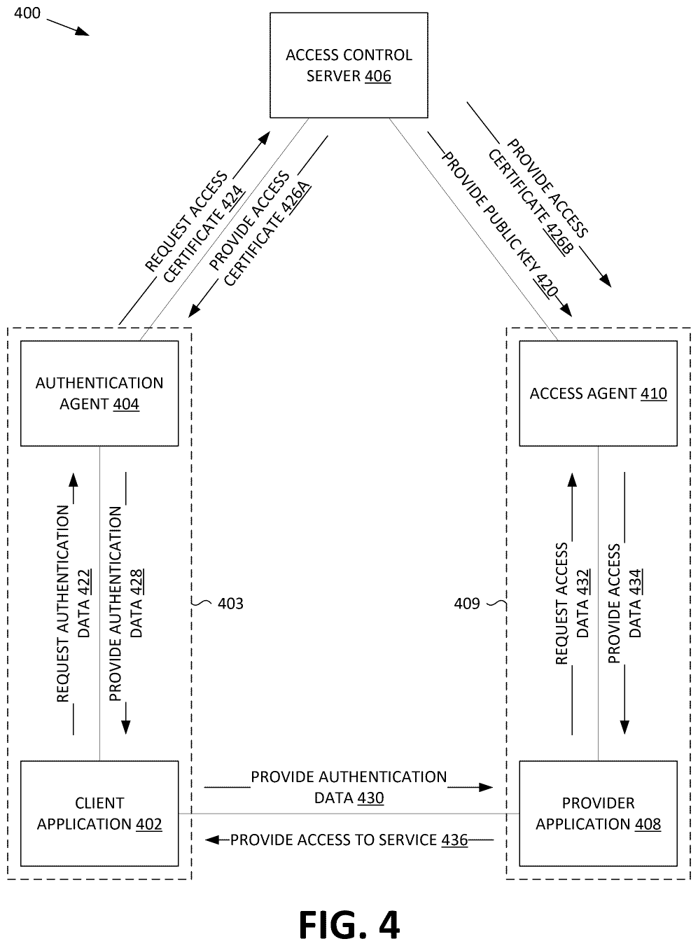

Authentication agent 154 may further provide compliance checking for client device 150. Authentication agent 154 may be a hardware component, a software component, or a combination thereof in various embodiments. Hardware and software authentication agents may provide various protections to prevent users from tampering with the compliance checking process. Examples of protections include integrity indicators to be sent with compliance indicators to access control server 160, integrity protocols and communication sequences with access control server 160 or other servers, and similar. Various examples are further described with respect to FIG. 4.

In an embodiment, authentication agent 154 may include an external hardware component that observes physical characteristics of client device 150, provides compliance test signals to client device 150, isolates compliance-related data (e.g., keys, software) from client device 150, or performs other compliance-related activities. Examples of external hardware components include a USB token, a trusted platform module (TPM), or a specialized PCIe card.

In an embodiment, authentication agent 154 may include a software component that observes activity of software and hardware systems of client device 150 (e.g., available hardware, OS and application activity, filesystem contents), provides compliance test signals to client device 150 (e.g., malware signatures), executes instructions to bring client device 150 into compliance (e.g., changes configurations automatically), or performs other compliance-related activities. Examples of software components include compiled binaries, scripts, libraries, security modules, etc.

FIGS. 2A-B depict example protocols 200 and 250 for client-side and server-side communication between applications and agents, respectively, in accordance with an embodiment. Protocols 200 and 250 may include application programming interfaces (APIs), inter-process communication (IPC) and various other messaging formats, techniques, and system configurations for sharing information between applications and agents.

Referring to FIG. 2A, authentication protocol 200 facilitates communication between client application 202 and authentication agent 204. In an embodiment, client application 202 may be service client 152 of FIG. 1, and authentication agent 204 may be authentication agent 154 or 156. Authentication protocol 200 may facilitate exchange of authentication information between various combinations of client applications and authentication agents. For example, ssh, scp, VPN clients, and web browsers may be client applications 202 that are compatible with authentication protocol 200. ssh-agent and various keyrings, password managers, and wallets may be authentication agents 204 that are compatible with authentication protocol 200. Authentication protocol 200 may be the ssh-agent protocol, the Assuan protocol, the Dbus protocol, etc. Some client applications 202 and authentication agents 204 may use different versions of authentication protocol 200 or different authentication protocols 200, and thus not all client applications 202 and authentication agents 204 may be compatible with each other in various embodiments (e.g., a web browser may not be compatible with ssh-agent).

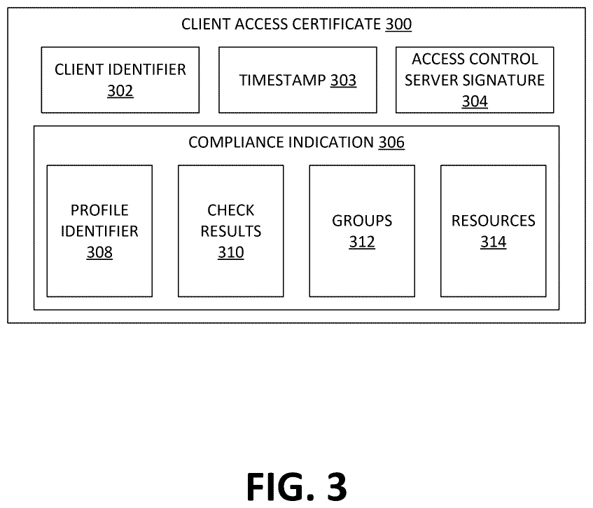

Authentication protocol 200 may support exchange of various types of authentication data such as username data, password data, public or private key data, certificate data, biometric data, and other data not depicted in FIG. 2A. For example, client application 202 may provide username data to a password manager authentication agent 200 and the password manager may provide password data in return. In an embodiment, where authentication agent 204 is authentication agent 154, authentication protocol 200 may support exchange of access certificates generated by access control server 160. In an embodiment, access control server 160 may generate access certificates in a format compatible with a preexisting authentication protocol 200. For example, access certificate data (e.g., as described with reference to FIG. 3) may be wrapped in a compatible certificate format.

Referring to FIG. 2B, access protocol 250 facilitates communication between server application 252 and access agent 254. In an embodiment, server application 252 may be service 132 of FIG. 1, and access agent 254 may be access agent 134 or 136. Access protocol 250 may facilitate exchange of access information between various combinations of server applications and access agents. For example, ssh servers, VPN endpoints, and web servers may be server applications 252 that are compatible with access protocol 250. Pluggable Authentication Modules (PAM) and Name Service Switch (NSS) may be access agents 254 that are compatible with access protocol 250. Access protocol 250 may be the PAM API, the NSS API, the NSS configuration in /etc/nsswitch.conf, etc. Some server applications 252 and access agents 254 may use different version of access protocol 250 or different access protocols 250, and thus not all server applications 252 and access agents 254 may be compatible with each other in various embodiments.

Access protocol 250 may support exchange of various types of access data such as authentication data (e.g., as described with reference to authentication protocol 200), user data (e.g., user name/number and permissions), group data (e.g., group membership and permissions), system data (e.g., connecting address or port), policy data (e.g., network or security policies), and other data not depicted in FIG. 2B. For example, server application 252 may provide user data of an incoming connection to PAM or NSS access agents 254, which may respectively provide identity verification data and group membership/permissions data in return. In an embodiment, where access agent 254 is access agent 134, access protocol 250 may support exchange of access certificates generated by access control server 160. In an embodiment, access control server 160 may generate access certificates in a format compatible with a preexisting access protocol 250. For example, access certificate data (e.g., as described with reference to FIG. 3) may be wrapped in a compatible certificate format.

FIG. 3 is a block diagram of an example client access certificate 300 (also referred to as “access certificate” herein), in accordance with an embodiment. Access certificate 300 may be provided by an access control server (e.g., access control server 160) to a service client (e.g., client device 150 or a service client thereon), which may use access certificate 300 to connect to a network service of a provider server (e.g., service 132 of provider server 130).

Access certificate 300 includes client identifier 302, which may be a cryptographic key, a hash, a unique name, or other data identifying the client device or service client. For example, identifier 302 may be a public key of an asymmetric key pair used for connecting to a network service. In another example, identifier 302 may be a universally unique identifier (UUID) or other unique identifier generated by the service client or assigned by another entity/device. In another example, identifier 302 may be another cryptographic certificate or associated public key included in access certificate 300 to establish a chain of trusted certificates. Identifier 302 may include combinations of these and other identifiers in various embodiments.

Access certificate 300 includes timestamp 303 which may indicate a time that access certificate 300 was created (or signed, sent, etc.) or a time that access certificate 300 expires (e.g., may no longer be used for access to a network service). Both types of timestamps may be provided, in some embodiments. Timestamps may be absolute or relative. For example, an absolute timestamp may be provided for a creation time, and a relative timestamp may be provided indicating the lifetime of access certificate 300. The expiration time can be determined by combining (e.g., adding) the two timestamps.

Access certificate 300 includes access control server signature 304, which may be a signature (e.g., generated using RSA, ECDSA, and/or other cryptographic schemes) of the access control server that enables the provider server to validate the authenticity of access certificate 300. Signature 304 may be associated with additional certificates and certificate authorities (CA) establishing a chain of trust under a trusted root CA. At least one CA in the chain (which may be the access control server) may be trusted by the provider server.

Access certificate 300 includes compliance indication 306 indicating that the client device/service client complies with one or more compliance profiles for various purposes. Various indications may be provided in various embodiments. For example, compliance indication 306 may include names, identifiers, or specifications of compliance profiles for which the service client is compliant (e.g., profile identifier 308). In another example, compliance indication 306 may include specifications, compliance check results, or other characteristics of the service client corresponding to the requirements of the compliance profile(s) (e.g., check results 310). In another example, compliance indication 306 may include groups or permissions that are available to the service client based on the service client's compliance level, such as administrator or root groups/permissions (e.g., groups 312). In yet another example, compliance indication 306 may identify services and other resources that the service client is permitted to access (e.g., as determined by the access control server) based on the service client's compliance level (e.g., resources 314). Compliance indication 306 may include combination of these and other compliance indications in various embodiments.

In various embodiments, fields of access certificate 300 depicted in FIG. 3 may be absent, or access certificate 300 may include additional fields and information not depicted in FIG. 3. For example, additional identifiers, timestamps, signatures, or indications may be included. Compliance indication 306 may indicate other resources available to the client, such as additional services or additional features within a service. Thus, access certificate 300 may be multipurpose by providing a client device access to multiple services, such as a VPN service to connect to a private network and an SSH service available on that private network. In an embodiment, access certificate 300 may be provided in a format or have fields expected by authentication modules on the client side or the server side. For example, access certificate 300 may conform to an authentication data format of a service protocol (e.g., VPN, SSH) or an authentication protocol (e.g., ssh-agent, PAM).

FIG. 4 is a communication diagram of an example interaction 400 between client application 402, authentication agent 404, access control server 406, provider application 408, and access agent 410 for providing fine-grained control for client access to network services, in accordance with an embodiment. In an embodiment, client application 402, authentication agent 404, access control server 406, provider application 408, and access agent 410 correspond to service client 152, authentication agent 154, access control server 160, service 132, and access agent 134 of FIG. 1, respectively. In an embodiment, client application 402 and authentication agent 404 are components of client device 403 (e.g., client device 150). In an embodiment, provider application 408 and access agent 410 are components of provider server 409 (e.g., provider server 130). In some embodiments, communications depicted in FIG. 4 could be performed in a different order or by different components than depicted. Various embodiments may include additional communications not depicted in FIG. 4 or a subset of communications depicted in FIG. 4. The communications depicted in FIG. 4 may correspond to different communication sessions or different timing intervals. For example, some communications may proceed in immediate succession or may be part of a single communication session, while other communications may be spread out over time or may be part of different communication sessions.

At communication 420, access control server 406 provides a public key to access agent 410. The public key may correspond to a private key (e.g., signing key 164) of an asymmetrical cryptosystem (e.g., RSA, ECDSA). Access control server 406 may use the private key for generating digital signatures for access certificates, and access agent 410 may use the public key for verifying access control server 406's signature. Access control server 406's public key may be signed by a mutually trusted certificate authority, or access agent 410 may trust the public key implicitly (e.g., when both access agent 410 and access control server 406 are part of the same entity or network). Access agent 410 may thus be able to identify a chain of trust for access certificates signed by access control server 406. In an embodiment, access control server 406 may provide its public key to access agent 410 via an intermediary, such as by posting it on the Internet or by providing it to a repository of certificates/keys later accessed by access agent 410. In an embodiment, the public key (or a certificate including the public key) may have limited lifetime (e.g., minutes, days, years, depending on the application). Thus, communication 420 may be performed again to deliver a new public key (or certificate) prior to expiration of the previous public key.

At communication 422, client application 402 requests authentication data from authentication agent 404 to access the service provided by provider application 408. The request may conform to an authentication protocol, such as authentication protocol 200 of FIG. 2 (e.g., the ssh-agent protocol).

At communication 424, authentication agent 404 requests an access certificate from access control server 406 to access the service provided by provider application 408. The request may include one or more compliance indicators generated by authentication agent 404. Authentication agent 404 may identify constituent compliance requirements of a compliance profile (e.g., provided by access control server 406 or provider application 408) and may perform corresponding compliance checks on client device 403. Authentication agent 404 may generate one or more compliance indicators, which may correspond to results of individual compliance checks or individual compliance requirements of the profile. The indicators may be Boolean (e.g., pass/fail) or may be other data types. For example, the compliance indicator for an OS-version check may be a string or integer corresponding to the OS version number. In another example, the compliance indicator may include cryptographic evidence of compliance generated by a trusted platform module (TPM) or other cryptographic component of client device 408.

In an embodiment, authentication agent 404 may receive one or more integrity indicators from access control server 406 or other source, which may be used to verify the authentication agent or other compliance components. Thus, authentication agent 404 may ensure that a provider of compliance components or a user of client application 402 has not modified or otherwise interfered with the function of the authentication agent/compliance components. The integrity indicator(s) may be a control hash corresponding to a hashed value of a compliance component or associated binary. Various other types of integrity indicators may be provided. The integrity indicator(s) may be received prior to communication 424.

In an embodiment, authentication agent 404 may further generate the integrity indicators, which may be used by access control server 406 to verify that client device 403 or the associated user did not interfere with or manipulate the compliance check process. For example, authentication agent 404 may calculate a hash of itself (e.g., of the compiled binary, script, etc.), which may be used by access control server 406 to verify that authentication agent 404 has not been changed. In other examples, authentication agent 404 may use specialized hardware (e.g., an external security key, a secure enclave as described with respect to FIG. 5), additional communication sequences with access control server 406 or other components, or various other protocols to generate an integrity indicator. The integrity indicators may be provided to access control server 406 with the compliance indicator(s) in communication 424, or the integrity indicators may be provided in a separate communication. Other data may be included in the access certificate request in various embodiments, such as an identifier of client device 403 or client application 402 (e.g., a public key to be used to connect to the service), an identifier of the service(s) to be connected to, timestamps, etc. In an embodiment, authentication agent 404 may receive compliance indicators, integrity indicators, or other request data from another component(s) of client device 403 (e.g., a separate compliance checking agent not depicted).

Other types of integrity protocols involving various integrity indicators generated and/or verified on a subset of devices 402-408 may be used in various embodiments.

Subsequent to receiving an access certificate request and compliance indicators from authentication agent 404 (e.g., in one request or in separate communications), access control server 406 may evaluate the compliance indicators to determine if the compliance requirements of the compliance profile are satisfied. Evaluating the compliance indicators may include observing a Boolean value (e.g., pass/fail), comparing a compliance indicator to a threshold value, double-checking the calculations performed by the compliance agent, or similar. In an embodiment, access control server 406 may also validate an included integrity indicator by, e.g., comparing a received hash to a known control hash, checking a digital signature, performing a series of communications with authentication agent 404 in a validation protocol, or similar. These integrity validations may be performed by authentication agent 404 in other embodiments.

If access control server 406 determines that the compliance requirements of the compliance profile are satisfied, determines that the integrity indicator is valid, or makes other necessary determinations related to the access certificate request, access control server 406 may proceed to generate an access certificate for the accessing the service. The access certificate may be access certificate 300 of FIG. 3. The access certificate may include an indication that client device 403 (or components thereof) complies with the compliance requirements of the compliance profile. The indication may be a Boolean value (complies/does not comply), an identifier of the compliance profile (e.g., a unique identifier), a listing of the compliance requirements and associated compliance indicators, etc. The indication may also identify resources of the service for which the client has permission to access (e.g., based on group membership, such as administrator, developer, unprivileged, etc.). The access certificate may further include an identifier of the client, such as a unique identifier or a public key to be used for VPN access. The access certificate may further include a timestamp(s) indicating a generation time or expiration time of the access certificate. Other data relevant to access control and other purposes may be included. The access certificate may include a digital signature of access control server 406, which may be generated using the private key associated with the public key provided in communication 420, such that the access certificate is verifiable by access agent 410. As previously discussed, the digital signature included in the access certificate may be associated with a certificate provided by a trusted certificate authority (or a chain of such certificates), which may enable access agent 410 to establish a chain of trust for the access certificate.

The generated access certificate may be a limited-duration access certificate valid up to the expiration time of the certificate. What is considered a limited-duration certificate may vary for different services and in different contexts. The lifetime of a limited-duration certificate may be determined by the frequency with which client device 403's compliance needs to be checked. For example, a limited-duration certificate may expire within a few minutes for a high-security service with frequent checks (e.g., a remote login service), a few hours for a medium-security service with somewhat frequent checks (e.g., a VPN service), and a few days for a low-security or non-security-focused service with infrequent checks (e.g., a web application). In an embodiment, the expiration time is determined by the service using a timestamp in the access certificate indicating creation/generation time.

At communication 426A, access control server 406 provides the access certificate to authentication agent 404. At communication 428, authentication agent 404 provides authentication data to client application 402 (e.g., using the authentication protocol). Authentication agent 404 may provide the access certificate directly to client application 402 as authentication data, or authentication agent 404 may modify or supplement the access certificate to generate the authentication data. For example, authentication agent 404 may embed the access certificate in a format that is compatible with the authentication protocol or service protocol (e.g., in a wrapper message). In an embodiment, authentication agent 404 may store the received access certificate to serve future requests from client application 402 (e.g., additional communications 422). Thus, access control server 406 may not be involved in future authentication data requests (e.g., communications 424 and 426A may not occur in future requests), which may reduce load on access control server 406 and connecting infrastructure (e.g., network 102) and which may reduce latency experienced by client device 403 and components or users thereof. In an embodiment, where the access certificate may expire after a period of time, authentication agent 404 may initiate additional communications 424 and 426A to renew that access certificate without involving client application 402.

At communication 430, client application 402 provides the authentication data (including the access certificate) to provider application 408 for accessing the service. At communication 432, provider application 408 requests access data from access agent 410. The request may conform to an access protocol, such as access protocol 250. Provider application 408 may provide the authentication data directly to access agent 410 as the access data request, or provider application 408 may modify or supplement the authentication data to generate the request. For example, provider application 408 may extract the access certificate from the authentication data and embed it in a format that is compatible with the access protocol (e.g., in a wrapper message). In another example, provider application 408 may include in the request, in addition to the access certificate, queries related to the connecting client's group membership and permissions (e.g., whether the client should be allowed to connect with administrator privileges). In an embodiment, access control server 406 provides the access certificate directly to access agent 410 (e.g., communication 426B) or through another intermediary.

Responsive to receiving the access certificate, access agent 410 may verify the digital signature in the access certificate using the public key provided in communication 420 as previously discussed. Access agent 410 may further verify that the compliance indication in the certificate corresponds to the compliance profile needed to access the service. Access agent 410 may further verify that the access certificate is active and not expired. Access agent 410 may further make determinations regarding the connecting client's identity and permissions based on the access data request, which may involve, e.g., other authentication and access modules of provider device 408. Access agent 410 may perform other verifications as necessary in various embodiments and may then provide access data to provider application 408 at communication 434 (e.g., using the access protocol). The access data may indicate whether the client is permitted to connect and what resources/permissions are available to the client. Based on the access data, provider application 408 may then provide client device 402 access to the service at communication 436. Provider application 408 or access agent 410 may periodically receive new access certificates demonstrating continued compliance before expiration of previous access certificates and may thus continue to allow access. If new access certificates indicate increased or decreased compliance (e.g., compliance corresponding to lesser, greater, or different compliance profiles), access agent 410 may determine a change in permissions and provider application 408 may increase or restrict access to capabilities of the service as a result. If client device 403 falls out of compliance or does not provide a new access certificate before expiration of a previous certificate, provider application 408 may end access and close the connection with client device 403.

In an embodiment, authentication agent 404 or access agent 410 may be absent, and relevant communications may occur directly between access control server 406 and client application 402 or provider application 408. For example, client application 402 may communicate with authentication agent 404 as depicted in FIG. 4, but provider application 408 may receive the public key (communication 420) directly from access control server 406 and may determine access privileges without an access agent. In another example, provider application 408 may communicate with access agent 410 as depicted in FIG. 4, but client application may request and receive an access certificate directly from access control server 406 without an authentication agent.

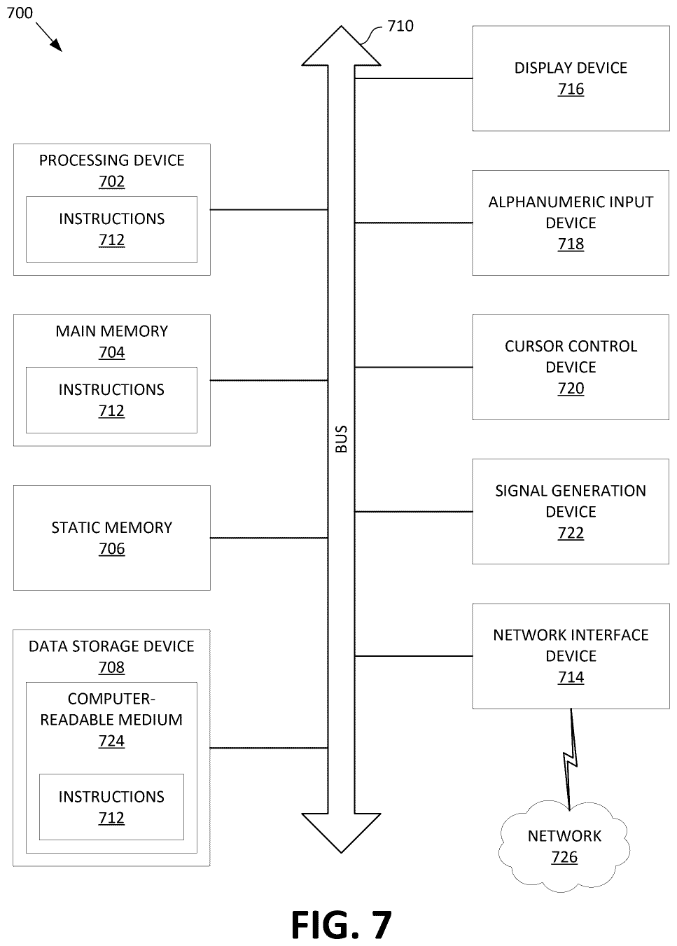

FIG. 5 is a flow diagram of an example method 500 for providing fine-grained control for client access to network services, in accordance with an embodiment. Method 500 may be performed by processing logic that may include hardware (e.g., circuitry, dedicated logic, etc.), computer-readable instructions such as software or firmware (e.g., run on a general-purpose computing system or a dedicated machine), or a combination thereof. For instance, an example system may include a memory and a processing device coupled to the memory device to perform operations including the blocks of method 500. Method 500 may also be associated with a set of instructions stored on a non-transitory computer-readable medium (e.g., magnetic or optical disk, etc.). The instructions, when executed by a processing device, may cause the processing device to perform operations including the blocks of method 500. In an embodiment, method 500 is performed by the system of FIG. 1 or components thereof (e.g., provider server 130, client device 150, access control server 160). In an embodiment, method 500 is performed by computing system 700 of FIG. 7. In some embodiments, blocks depicted in FIG. 5 could be performed simultaneously or in a different order than depicted. Various embodiments may include additional blocks not depicted in FIG. 5 or a subset of blocks depicted in FIG. 5. For example, block 510 may be absent in an embodiment, as indicated by dashed outlines.

At block 502, processing logic of a client device receives, by an authentication agent of the user device, a request of a service client of the user device for authentication data to access a service provided by a host server. The client device may be client devices 150 or 403 of FIGS. 1 and 4. The authentication agent may be authentication agents 154 or 404. The service client may be service client 152 or client application 402. The service provided by the host server may be service 132 of provider server 130 or may be provided by provider application 408 of provider device 409. Receiving the request may correspond to communication 422. The request may be received over an authentication protocol such as an API, IPC, etc. as described with reference to FIGS. 2 and 4.

At block 504, the processing logic requests, by the authentication agent, an access certificate from an access control server, the request including one or more compliance indicators of the user device associated with one or more compliance requirements for accessing the service. The access control server may be access control servers 160 or 406. The access certificate request may correspond to communication 424. The compliance requirements for accessing the service may be associated with a compliance profile, and each compliance requirement may include one or more compliance checks to be performed by the authentication agent or other compliance component of the user device. The compliance indicators may include results of the compliance checks. In an embodiment, the one or more compliance requirements are associated with a configuration communication between the access control server and the host server. For example, provider server 130 (or a component thereof) may configure access control server 160 to generate access certificates after verifying client compliance with specific compliance requirements chosen by provider server 130 (or an administrator entity) based on the security needs or other needs of service 132.

In an embodiment, the request for the access certificate further comprises a request integrity indicator. The request integrity indicator may be a hash of a compiled set of instructions, wherein the compiled set of instructions is provided to the user device to perform compliance checking and generate compliance indicators. For example, the compiled set of instructions may be authentication agent 154 or another compliance agent. The hash may be known to the access control server. For example, the hash may be provided to the access control server by the host server or administrator of the service for validating the request integrity indicator.

At block 506, the processing logic receives, by the authentication agent, the access certificate from the access control server, the access certificate including: an indication that the user device complies with one or more compliance requirements, and a digital signature of the access control server. The access certificate may be access certificate 300 and may include the indication (e.g., compliance indication 306), and digital signature (e.g., signature 304) as described with respect to FIG. 3. For example, the digital signature may be generated with a private key of the access control server (e.g., key 164). In an embodiment, the access certificate further comprises a public key of the user device and an indication of one or more memberships of the user device in one or more resource groups (e.g., administrator resource group, unprivileged user resource group). The public key may be used, for example, to encrypt communications between the user device and the service. The access certificate may include other information such as timestamps, resource permissions, etc. In various embodiments, some of example fields described above may be omitted from the access certificate.

At block 508, the processing logic provides, to the service client, the access certificate to be sent to the host server for validation using a public key of the access control server. The access certificate may be provided over the authentication protocol described with respect to block 502. The access certificate may be sent to the host server with a service protocol. In an embodiment, the service client communicates with the host server using the SSH protocol, and the authentication agent communicates with the service client using the SSH Agent protocol. In an embodiment, the authentication agent is a modular authentication agent that is interchangeable with a second authentication agent not in communication with the access control server. For example, authentication agent 154 may be in communication with access control server 160 and may be interchangeable with authentication agent 156, which may not be in communication with access control server 160 (e.g., the ssh-agent authentication agent). In an embodiment, the service client is a modular service client that is interchangeable with another service client in communication with a different service. For example, ssh and scp service clients are interchangeable with respect to the ssh-agent authentication protocol but provide different service s—secure shell and secure copy.

In an embodiment, the user device further uses the access certificate to connect to a virtual private network (VPN) associated with the host server prior to the service client sending the access certificate to the host server for validation. For example, the host server may be located on a private network, such as an enterprise network. The user device may be required to connect to the private network over VPN before the service becomes accessible to the user device—the user device may be unable to route to the host server otherwise. The user device may provide the access certificate to a VPN endpoint server on the private network (e.g., using a VPN service client on the user device) to access the private network. The user device may proceed to use the same access certificate to access the service hosted within the private network as described above.

In an embodiment, the access certificate is a limited-duration access certificate. For example, the access certificate may have an expiration time of minutes, hours, days, etc. after it was generated. At block 510, the processing logic requests in a second request, prior to an expiration time of the access certificate, a second access certificate from the access control server, the second request including one or more continued compliance indicators. As described with respect to FIG. 4, the second request may be initiated automatically by the authentication agent or in response to request for updated authentication data from the service client. In the former scenario, the authentication agent may store current and updated access certificates and provide them to the service client upon request. The continued compliance indicators may be different than the compliance indicators of the request of block 504, e.g., corresponding to increased or decreased compliance. The host server may increase or decrease access to the service as a result upon receiving the second access certificate from the service client.

### Computer Systems

FIG. 6 illustrates an example network server 600 with an access control service 630 for providing fine-grained control for client access to network services, according to an embodiment. Access control service 630 includes signing key 631, which may be used to digitally sign access certificates, and which may correspond to a public key used to verify access certificate signatures. In an embodiment, network server 600 running access control service 630 may correspond to access control server 160 of FIG. 1 or access control server 406 of FIG. 4. Signing key 631 may correspond to signing key 164 of FIG. 1.

As shown in FIG. 6, network server 600 may include processing device 610 that may execute operating system 620. Furthermore, processing device 610 may include one or more internal cryptographic keys 611 that may be used to encrypt and decrypt data stored in a portion of a memory that is assigned to a secure enclave of access control service 630. The access to the data of access control service 630 in the secure enclave (e.g., profiles, certificates, and keys stored at a storage resource) may be protected from one or more applications 640A-n and operating system 620. For example, the access to the data of the secure enclave corresponding to access control service 630 may be protected by the use of one of internal cryptographic keys 611 that are internal to processing device 610 so that the access to the data is based on a hardware access as opposed to a software access. Operating system 620 may be associated with a first privilege level and access control service 630 and applications 640A-n may be associated with a second privilege level where the first privilege level of the operating system is more privileged than the second privilege level of the various applications that are run on operating system 620 (e.g., the more privileged level allows access to more resources of the network server than the less privileged level). Thus, operating system 620 may be allowed access to resources of applications 640A-n. However, since access control service 630 is assigned to a secure enclave where access to the data of the secure enclave is based on the use of an internal cryptographic key 611 of processing device 610, operating system 620 may not be able to access the data of access control service 630 despite having a more privileged level of access than access control service 630. The master key that is used to decrypt data at the storage resource may be an internal cryptographic key 611.

In operation, a client device (e.g., client device 150 of FIG. 1) may request an access certificate from access control service 630. Since access control service 630 is assigned to a secure enclave, the signing key or compliance profiles of access control service 630 may be encrypted and protected by the use of an internal cryptographic key 611 (i.e., the master key) of processing device 610. Access control service 630 may subsequently use an instruction so that processing device 610 may use one of its internal cryptographic keys 611 to decrypt the data of the secure enclave of access control service 630 and to retrieve the data. Subsequently, a cryptographic operation such as signing an access control certificate may then be performed by processing device 610 and then the output of the cryptographic operation may be provided to access control service 630 which may return the output the client device as a generated access certificate. In some embodiments, internal cryptographic key 611 may be combined with additional information (e.g., the identification information of access control service 630) to generate the master key for access control service 630 that is used to decrypt and/or encrypt data associated with the secure enclave of access control service 630. Thus, since processing device 610 uses its internal cryptographic key 611 to decrypt data and to perform the cryptographic operation, the signing key 631 and other access control-related data may not be exposed external to processing device 610. Network services (and associated administrators and organizations) may thus be assured that access certificates issued by access control service 630 have not been tampered with at network server 600 and may therefore trust access certificates received from client devices.

FIG. 7 is a block diagram illustrating an example computer system 700, in accordance with implementations of the present disclosure. Computer system 700 may correspond to provider server 130, client device 150, or access control server 160, as described with respect to FIG. 1. Computer system 700 may also correspond to network server 600, described with respect to FIG. 6. Computer system 700 may operate in the capacity of a server or an endpoint machine in endpoint-server network environment, or as a peer machine in a peer-to-peer (or distributed) network environment. The machine may be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 700 includes processing device 702 (e.g., one or more processors or cores), main memory 704 (e.g., read-only memory (ROM), flash memory, dynamic random access memory (DRAM) such as synchronous DRAM (SDRAM), double data rate (DDR SDRAM), or DRAM (RDRAM), etc.), static memory 706 (e.g., flash memory, static random access memory (SRAM), etc.), and data storage device 708, which communicate with each other via bus 710.

Processing device 702 represents one or more general-purpose processing devices such as a microprocessor, central processing unit, or the like. More particularly, processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. Processing device 702 is configured to execute instructions 712 (e.g., for providing fine-grained control for client access to network services) for performing the operations discussed herein.

Computer system 700 may further include network interface device 714. Computer system 700 also may include display device 716 (e.g., a liquid crystal display (LCD) or a cathode ray tube (CRT)), alphanumeric input device 718 (e.g., a keyboard, and alphanumeric keyboard, a motion sensing input device, touch screen), cursor control device 720 (e.g., a mouse), and signal generation device 722 (e.g., a speaker). In some embodiments, computer system 700 may not include display device 716, alphanumeric input device 718, and/or cursor control device 720 (e.g., in a headless configuration).

Data storage device 708 may include a non-transitory machine-readable storage medium 724 (also computer-readable storage medium) on which is stored one or more sets of instructions 712 (e.g., for providing fine-grained control for client access to network services) embodying any one or more of the methodologies or functions described herein. Instructions 712 may also reside, completely or at least partially, within main memory 704 or within the processing device 702 during execution thereof by computer system 700, main memory 704 and processing device 702 also constituting machine-readable storage media. Instructions 712 may further be transmitted or received over network 726 via network interface device 714.

In one implementation, instructions 712 include instructions for providing fine-grained control for client access to network services, as described herein. While computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing certain terms may refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

As used in this application, the term “or” is intended to mean an inclusive “or” rather than an exclusive “or. ” That is, unless specified otherwise, or clear from context, “A or B” is intended to mean any of the natural inclusive permutations (e.g., A and B, A and not B, B and not A). In addition, the articles “a” and “an” as used in this application and the appended claims should generally be construed to mean “one or more” unless specified otherwise or clear from context to be directed to a singular form.

Furthermore, the terms “one implementation,” “one embodiment,” “an implementation,” “an embodiment,” or similar mean that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

What is claimed is:

1. A method comprising:
receiving, by an authentication agent of a user device, a request of a service client of the user device for authentication data to access a service provided by a host server;
requesting, by the authentication agent, an access certificate from an access control server, the request comprising one or more compliance indicators of the user device associated with one or more compliance requirements for accessing the service;
receiving, by the authentication agent, the access certificate from the access control server, the access certificate comprising:
an indication that the user device complies with the one or more compliance requirements, and
a digital signature of the access control server; and
providing, to the service client, the access certificate that is to be sent to the host server for validation using a public key of the access control server.

2. The method of claim 1, wherein the authentication agent of the user device is a modular authentication agent, and wherein the modular authentication agent is interchangeable with a second authentication agent not in communication with the access control server.

3. The method of claim 1, wherein the service client communicates with the host server using a Secure Shell (SSH) protocol, and wherein the authentication agent of the user device communicates with the service client using a SSH Agent protocol.

4. The method of claim 1, wherein the access certificate is a limited-duration access certificate, the method further comprising:
requesting using a second request, prior to an expiration time of the limited-duration access certificate, a second limited-duration access certificate from the access control server, the second request comprising one or more continued compliance indicators.

5. The method of claim 1, wherein the access certificate further comprises a public key of the user device and an indication of one or more memberships of the user device in one or more resource groups of the host server.

6. The method of claim 1, further comprising:
using a second access certificate to connect to a virtual private network (VPN) associated with the host server prior to the service client sending the access certificate to the host server for validation.

7. The method of claim 1, wherein the one or more compliance requirements are associated with a configuration communication between the access control server and the host server.

8. A system comprising:
a memory device; and
a processing device coupled to the memory device, the processing device to perform operations comprising:
receiving, by an authentication agent of the system, a request of a service client of the system for authentication data to access a service provided by a host server;
requesting, by the authentication agent, an access certificate from an access control server, the request comprising one or more compliance indicators of the system associated with one or more compliance requirements for accessing the service;
receiving, by the authentication agent, the access certificate from the access control server, the access certificate comprising:
an indication that the system complies with the one or more compliance requirements, and
a digital signature of the access control server; and
providing, to the service client, the access certificate that is to be sent to the host server for validation using a public key of the access control server.

9. The system of claim 8, wherein the authentication agent of the system is a modular authentication agent, and wherein the modular authentication agent is interchangeable with a second authentication agent not in communication with the access control server.

10. The system of claim 8, wherein the service client communicates with the host server using a Secure Shell (SSH) protocol, and wherein the authentication agent of the system communicates with the service client using an SSH Agent protocol.

11. The system of claim 8, wherein the access certificate is a limited-duration access certificate, the operations further comprising:
requesting using a second request, prior to an expiration time of the limited-duration access certificate, a second limited-duration access certificate from the access control server, the second request comprising one or more continued compliance indicators.

12. The system of claim 8, wherein the access certificate further comprises a public key of the system and an indication of one or more memberships of the system in one or more resource groups of the host server.

13. The system of claim 8, the operations further comprising:
using a second access certificate to connect to a virtual private network (VPN) associated with the host server prior to the service client sending the access certificate to the host server for validation.

14. The system of claim 8, wherein the one or more compliance requirements are associated with a configuration communication between the access control server and the host server.

15. A non-transitory computer-readable medium comprising instructions that, when executed by a processing device, cause the processing device to perform operations comprising:
receiving, by an authentication agent of a user device, a request of a service client of the user device for authentication data to access a service provided by a host server;
requesting, by the authentication agent, an access certificate from an access control server, the request comprising one or more compliance indicators of the user device associated with one or more compliance requirements for accessing the service;
receiving, by the authentication agent, the access certificate from the access control server, the access certificate comprising:
an indication that the user device complies with the one or more compliance requirements, and
a digital signature of the access control server; and
providing, to the service client, the access certificate that is to be sent to the host server for validation using a public key of the access control server.

16. The non-transitory computer-readable medium of claim 15, wherein the authentication agent of the user device is a modular authentication agent, and wherein the modular authentication agent is interchangeable with a second authentication agent not in communication with the access control server.

17. The non-transitory computer-readable medium of claim 15, wherein the service client communicates with the host server using a Secure Shell (SSH) protocol, and wherein the authentication agent of the user device communicates with the service client using an SSH Agent protocol.

18. The non-transitory computer-readable medium of claim 15, wherein the access certificate is a limited-duration access certificate, the operations further comprising:
requesting using a second request, prior to an expiration time of the limited-duration access certificate, a second limited-duration access certificate from the access control server, the second request comprising one or more continued compliance indicators.

19. The non-transitory computer-readable medium of claim 15, wherein the access certificate further comprises a public key of the user device and an indication of one or more memberships of the user device in one or more resource groups of the host server.

20. The non-transitory computer-readable medium of claim 15, the operations further comprising:
using a second access certificate to connect to a virtual private network (VPN) associated with the host server prior to the service client sending the access certificate to the host server for validation.
